(19) United States
(12) Patent Application Publication
(10) Pub. No.: US 2020/0098071 A1
(43) Pub. Date: Mar. 26, 2020

(54) MASS TORT MANAGEMENT, INVESTMENT, AND PROCUREMENT MODULE

(71) Applicant: Jay M. Jackson, Houston, TX (US)

(72) Inventor: Jay M. Jackson, Houston, TX (US)

(21) Appl. No.: 16/576,175

(22) Filed: Sep. 19, 2019

Related U.S. Application Data
(60) Provisional application No. 62/734,438, filed on Sep. 21, 2018.

(51) Int. Cl. G06Q 50/18; G06F 9/54

(52) U.S. Cl. CPC G06Q 50/18; G06F 9/542

(57) ABSTRACT

A mass tort management, investment, or procurement module seamlessly combines and enhances attorney investing, managing, and trading of mass tort cases. The mass tort management, investment, or procurement module provides a synergistic solution which allows attorneys to research, acquire, and manage mass tort cases, all while providing full accountability and transparency. With the mass tort, investment, or procurement management module, legal entities are able to connect with other legal entities and potential plaintiffs, estimate and purchase legal rights of the potential plaintiffs, and track litigation related data. The mass tort management, investment, or procurement module is included in a larger mass tort management, investment, or procurement system which revolutionizes how mass tort litigation proceedings will be handled among legal entities.

### CROSS REFERENCE TO RELATED APPLICATIONS

This application claims priority under 35 U.S.C. § 119 to provisional patent application U.S. Ser. No. 62/734,438, filed Sep. 21, 2018. The provisional patent application is herein incorporated by reference in its entirety.

### FIELD OF THE INVENTION

The present invention relates generally to a software implemented method for use in at least the mass tort litigation and legal finance industries.

### BACKGROUND OF THE INVENTION

Attorneys compete with one another to acquire cases. Nowhere is this more evident or aggressive than in the world of mass tort law. Mass tort attorneys and law firms routinely invest millions of dollars in an effort to acquire large dockets with hundreds or even thousands of cases at a time. This ‘docket stockpiling’ occurs in the well-defined universe of ‘active’ torts. And, by tracking the money spent in mass tort advertising, we find, there are generally ten to twenty “must have” torts active at any given time. Large Mass Tort conferences, such as Mass Torts Made Perfect, regularly hold training sessions for lawyers on the ‘hot’ and ‘up and coming’ torts and fill convention floors with hundreds of legal vendors ready to help them procure these cases.

Playing in the mass tort arena is a high-stakes gamble. Winning big can result in more than a ten-fold return on investment (settlement fees received compared to case acquisition and work up costs), however, large losses are commonplace. Over the last 10 years, about three out of every five torts have settled far below expectations or were completely tossed out of the judicial system.

The mass tort world has grown exponentially in the last 20 years. Competition has become fierce and the business models and methods have grown vastly more sophisticated. Dozens of new companies pop-up each year to support law firms with their investing, financing, marketing, advertising, and intake strategies. Simultaneously, data advancements of all types, from real-time ‘marketing spend and lead generation’, including updates from TV stations, social media, and Google's pay-per-click campaigns, have forged a new world of metrics surrounding including ‘cost-per-lead’, ‘lead-to-case conversion’, and ‘cost-per-case’. Recently, various social media networks have upped access to data even more by delivering these metrics in ways vastly more applicable to the mechanics of case acquisition. For signing cases and managing dockets, robust intake software provides a wealth of data for those who know how to apply it. Cutting edge mass tort consulting, education and training companies, wishing to help attorneys new to the space, are beginning to develop crude formulas with financial viability, potential plaintiff numerosity, case duration and cost per client acquired. It's being called the “data revolution” in the mass tort circles.

Yet, acquiring these cases (or ‘investing’ in them as they are acquired and referred to other firms) is still typically done by manually placing a phone call, similar to how many stocks were sold in the 1970s before home computers prompted the influx of research, analytical, and purchasing tools. This “insider” method of mass tort investments, with its deliberate lack of transparency, works to keep all but the most advanced lawyers either out of the game or chasing their tail and hoping their investment and their docket is “lucky.”

Reports, usually as excel spreadsheets, are sent to the lawyer from marketing companies, the intake teams, and others involved in the process—all capturing a manual ‘piece’ of the process—but with no overall system in place for actual investment analysis. Thus, data is scattered in numerous places and the lack of ability to compile, interpret, and apply data into or from a single location without straining the capabilities of associated hardware is a major problem for those wishing to take a logical, empirical, and scientific approach to investing into mass torts.

So, while useful data is finally accessible, there still exists a need in the field for a system (via specialized software) capable of making it useful. A solution for compiling, unifying data from all these legal data sources, for assigning values, rating and weighing them, calculating them against criterion, and getting this new information into a useful form and where it needs to be—in front of attorneys with a set of individualized tools, that they can use when researching and making decisions about which torts to get involved in and in what capacity. Addressing these needs are not so simple, as the more robust, specialized software would need to be built that combines all of these research goals with a holistic solution for then acting on this research, investing into the cases dockets and then managing the acquisition process and measuring effectiveness.

### SUMMARY OF THE INVENTION

In the mass tort industry, acquiring, understanding, and applying “data” has always played a role in navigating the business aspect of case acquisition, but never as much as now. Beyond the research that is required, tracking all the marketing spends, the case costs, the case flow, the fee splits, and more, through all the stages of the lead generation and intake processes, is a huge job. Staying on top of all the opportunities and understanding the risks means staying in touch with all the latest news and developments.

On the surface, ‘commoditizing’ the legal system seems perhaps a bit harsh, given that these very cases being bought and sold, relate to real people with legitimate legal problems. However, viewing case acquisition as a business can actually facilitate the connection of top-level legal talent with those in need of representation on fair and reasonable terms. For mass tort lawyers, deftly acquiring cases is a complicated proposition. The costs, risks, and potential rewards are always in motion and the market evolves continuously. Successfully navigating in the mass torts arena means staying one step ahead of the competition and requires a commanding knowledge of a great deal of ever-evolving information.

Therefore, a primary objective, feature, and/or advantage of the present invention is to address, improve on, and/or overcome the deficiencies in the process, and thus provide more robust, specialized software capable of managing all aspects of mass tort case acquisition in real time.

It is still yet a further object, feature, and/or advantage of the present invention to provide a software application and associated hardware that gives an attorney and/or a law firm the ability to easily act based upon a large amount of information.

It is still yet a further object, feature, and/or advantage of the present invention to provide a software application and associated hardware that which considers more parameters of mass tort data than just cost-per-case, including but not limited to: the number of similar and/or competing claims; how identifiable or reachable those that are harmed are; how responsive those harmed are to advertising; chance of success or failure of potential litigation; how many other law firms are competing to litigate a similar case; how long the attorney's or law firm's investment is likely to be tied up; and the like.

It is still yet a further object, feature, and/or advantage of the present invention to provide a software application and associated hardware that takes an objective approach to dealing with the ‘up and down’ volatility of mass tort litigation cases, similar to the ‘up and down’ volatility found in the stock market. For example, software application and associated hardware should give mass tort lawyers the ability to more easily weigh a plethora of market factors to determine the biggest returns with the least amount of risk.

It is still yet a further object, feature, and/or advantage of the present invention to provide a software application and associated hardware that may be used for a wide variety of applications. For example, the software application and associated hardware could be used in other areas of the law than just mass torts or even in industries other than just the legal finance industry.

It is still yet a further object, feature, and/or advantage of the present invention to provide a secure, cost effective, and durable software application in connection with appropriate hardware for running the software application. For example, the software application and associated hardware will, preferably, include a mass tort management, investment, or procurement module which (1) restricts third parties from accessing user specific information; (2) protects against viruses, worms, trojans, bots, other types of malware, and phishing or other methods of stealing personal information; (3) uses as little power as necessary; and (4) interferes with other software applications, modules, or devices as little as possible so that functions of the same may be performed as usual.

It is still yet a further object, feature, and/or advantage of the present invention to provide a graphical user interface including a distinct aesthetic appearance.

It is still yet a further object, feature, and/or advantage of the present invention to practice methods which facilitate use, manufacture, assembly, maintenance, and repair of a software application and/or associated hardware accomplishing some or all of the previously stated objectives.

It is still yet a further object, feature, and/or advantage of the present invention to incorporate the software application, associated hardware, and/or mass tort module into a non-transitory computer readable medium accomplishing some or all of the previously stated objectives.

The previous objects, features, and/or advantages of the present invention, as well as the following aspects and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part. These and/or other objects, features, advantages, aspects, and/or embodiments will become apparent to those skilled in the art after reviewing the following brief and detailed descriptions of the drawings.

### BRIEF DESCRIPTION OF THE DRAWINGS

FIG. 1 shows an exemplary mass tort litigation management system.

FIG. 2 shows an example of how data is received from a data source, transformed by the mass tort litigation system, and ultimately communicated to a user for mass tort investment considerations.

FIG. 3 shows an exemplary hardware environment for practicing the present invention.

FIG. 4 shows a diagram illustrating exemplary functions of and/or steps carried out by the communications module.

FIG. 5 shows a diagram illustrating exemplary functions of and/or steps carried out by the mass tort management, investment, or procurement module.

FIG. 6 shows an exemplary image of an estimation balancing epidemiology, jurisdictional, and legality considerations of tort cases and/or leads.

FIG. 7 shows a diagram illustrating exemplary functions of and/or steps carried out by the marketing submodule.

FIG. 8 shows a diagram illustrating exemplary functions of and/or steps carried out by the docketing submodule.

FIG. 9 shows a diagram illustrating exemplary functions of and/or steps carried out by the payment submodule.

Several embodiments in which the present invention may be practiced are illustrated and described in detail, wherein like reference characters represent like components throughout the several views. The drawings are presented for exemplary purposes.

### DETAILED DESCRIPTION OF THE INVENTION

### Definitions—Introductory Matters

The following definitions and introductory matters are provided to facilitate an understanding of the present invention. Unless defined otherwise, all technical and scientific terms used herein have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” as used herein are not intended to refer to any single embodiment of the particular invention but encompass all possible embodiments as described in the specification and the claims.

The term “about” as used herein refers to slight variations in numerical quantities with respect to any quantifiable variable. One of ordinary skill in the art will recognize inadvertent error can occur, for example, through use of typical measuring techniques or equipment or from differences in the manufacture, source, or purity of components. The claims include equivalents to the quantities whether or not modified by the term “about.”

The term “configured” describes an apparatus, system, or other structure that is constructed to perform or capable of performing a particular task or to adopt a particular configuration. The term “configured” can be used interchangeably with other similar phrases such as constructed, arranged, adapted, manufactured, and the like.

Terms characterizing a sequential order (e.g., first, second, etc.) are not limiting unless otherwise noted.

The term “mass tort” refers to a civil action involving numerous plaintiffs against one or more defendants in state or federal court. In some cases, mass torts are addressed through a “class action.” Attorneys and law firms sometimes use “mass media” to reach potential plaintiffs for class action lawsuits. Common areas of mass tort litigation relate to medical devices, prescription drugs, product liability injuries, and toxic contamination.

In communications and computing, a computer readable medium is a medium capable of storing data in a format readable by a mechanical device. The term “non-transitory” is used herein to refer to computer readable media (CRM) that store data for short periods or in the presence of power such as a memory device or random-access memory (RAM).

In computing, a processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, and other computing devices capable of allowing input, providing options, and showing output of electronic functions.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

As would be apparent to one of ordinary skill in the art, mechanical, electrical, programmatic, procedural, or other changes may be made without departing from the spirit and scope of the invention. The scope of the invention is defined only by the appended claims, along with the full scope of equivalents to which such claims are entitled.

### Overview

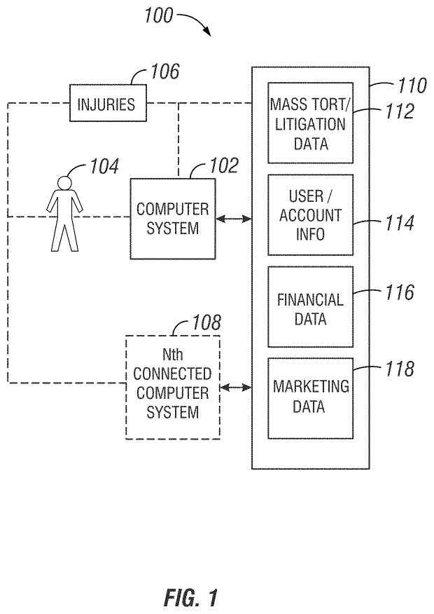

FIG. 1 shows a mass tort management, investment, or procurement system 100 which comprises at least a non-transitory computer readable medium 102. A user 104, such as an attorney, a marketing firm, or even an injured party may use the non-transitory computer readable medium 102 in connection with associated software to, for example, track injuries 106, purchase legal rights, and/or docket litigation related deadlines. It is to be appreciated any number of additional computer readable media 108 can be integrated into the mass tort management, investment, or procurement system 100.

The non-transitory computer readable medium 102 can be a standalone device or can form part of a mobile phone (for more instant accessibility to the mass tort management, investment, or procurement system 100), gaming console, tablet, other computing device, or even a software application usable with a computing device such as a web browser. The non-transitory computer readable medium 102 acts as the primary means for which the functions and/or steps of the present disclosure may be practiced by person(s) considered to be the user 104. Accordingly, the user 104 is typically the primary benefactor of the mass tort management, investment, or procurement system 100 and is the one who can give manual input to the non-transitory computer readable medium 102, if necessary.

Injuries 106 are harms to a particular person or party which occur as a result of a real-world event. However, for the sake of the present disclosure, injuries 106 are meant to include any civil wrong that causes a claimant to suffer loss or harm resulting in legal liability for the person who commits the tortious act and can include bodily and health related issues (such as cancer), the infliction of emotional distress, negligence, financial losses, invasion of privacy, and the like. The injuries 106 may be automatically tracked in some manner, such as through access to a hospital database. Those tracking injuries 106 in this manner should be careful not to violate any laws or regulations under the Health Insurance Portability and Accountability Act of 1996 (HIPAA). The severity of injuries 106 may be evaluated by medical professionals or even through the partial use of sensors. Sensors can help monitor and determine whether an injury has occurred and can comprise, for example, heart rate sensors, breathing (airflow) sensors, temperature sensors, audio sensors (for monitoring vocal tone, pitch, and volume), pressure sensors, timers, motion detectors, gyroscopes, x-rays, MRI and other imaging tools, and the like.

The non-transitory computer readable medium 102 and/or or other non-transitory computer readable media 108 have access to database(s) 110 which store mass tort/litigation data 112, user/account information 114, financial data 116, marketing data 118, and/or other types of data. The database 110 is a structured set of data stored in a computer and is preferably one that is accessible in various ways. The database 110, as well as data and information contained therein, need not reside in a single physical or electronic location. For example, the database 110 may reside, at least in part, on a local storage device, in an external hard drive, on a database server connected to a network, on a cloud-based storage system, in a distributed ledger (such as those commonly used with blockchain technology), and/or the like.

Stored data may be updated periodically, in real time, or in response to an input from the user 104. Some types of data may be accessible by the user 104, while other types of data may be restricted or partially restricted (e.g., behind a paywall) from the view of the user 104. For example, a user 104 in a law firm may have total access to both mass tort/litigation data 112 and user/account information 114 relating to their own account. In another example, marketing data 118 may be reserved for view by users 104 in marketing firms. In yet another example, some financial data 116 may be viewed by both users 104 of law firms and marketing firms while other financial data 116 may be restricted from the view of users 104 of both law firms and marketing firms. The database 110 obtains the data from various sources.

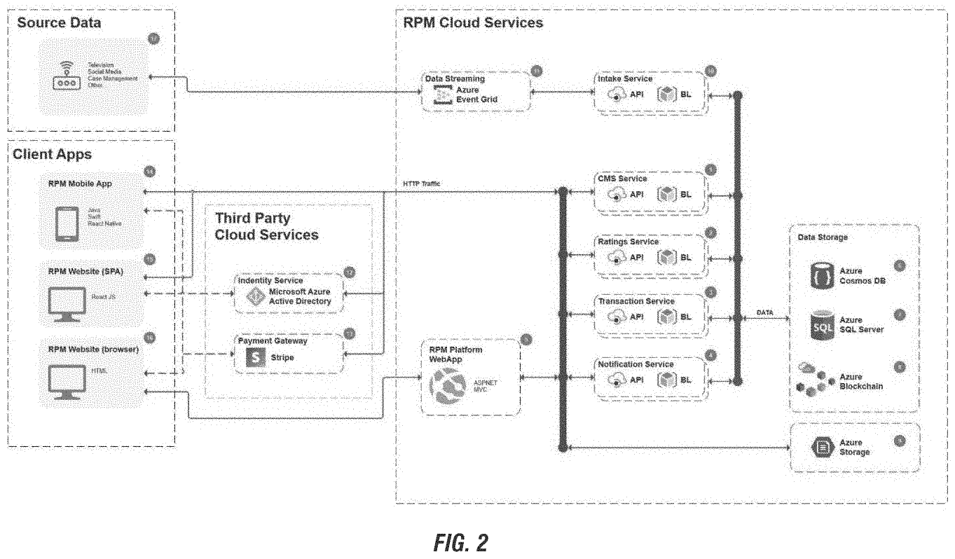

For example, the database 110 may obtain data from actual advertising/marketing campaigns in real-time, API-ed into mass tort management, investment, or procurement system 100 from some of the largest legal mass tort marketing companies in the business, as shown (in an exemplary manner) in FIG. 2. In return, advertising/marketing campaigns get data directly from television stations and social media platforms on which they (and their clients) advertise. The marketing data 118 could, for example, say “there are XX law firms participating/advertising”, the litigation data 112 could, for example, say “this is how many leads are being created as they happen”, and the financial data 116 could, for example, say “each lead costs $$.$$, however could change in X amount of time.”

In addition, the database 110 may obtain data directly from intake departments within law firms signing the cases—thus incorporating the first-ever “feedback loops” (created by out partners, the users of this solution) into the mass tort management, investment, or procurement system 100. Thus, it would be known how many of these leads are “closing” (signing a contract with a law firm) and there will be ample amount of data to accurately estimate a cost-per-case—in real-time.

In addition, the database 110 may obtain historical data and may observe changes in said historical data over time, and in real time. By saving the historical data, a streaming landscape view of changes in the data can be observed, thus showing trends, mapping where a tort has been towards where a tort is going. Historical data can be tracked across any period of time (a full day, a week, month, or the entire history of the tort itself) for a macro view into the acquisition tendencies, drifts and directional leanings. From there, the next data-cycle occurs, adding landscape data, which includes: if the case in a positive direction, if there are legal arguments getting stronger, what is effected by the life cycle of the tort maturing, the estimated tort size, the number of cases that have been signed (and thus the number of cases that remain available), the number of firms filing tort cases, how many tort cases are filed, and hundreds of other data points being updated continuously.

A second type of historical data is industry data, and similar torts have often preceded the ones in the news and in our tool today. Data on client retention, and settlement value, are key and can add depth and details to estimations. The tort management system 100 effectively has access to all of the original or other similar settlements.

Data can be taken from panels of experts, as experts are a key source of data, helping to calculate value, risk, and how much a case is worth. Experts can include highly sophisticated members of the mass tort litigation community, but more often simply include the community itself. For example, litigating firms can often be best to determine what the litigating firms are looking for, and what types of data best correlate with their success. Trends in case acquisition, for example, are often what are the hedge funds are willing to sponsor. The community is encouraged to comment, share insights, and share case information, which can also be a driver in adjusting and coloring the numbers. The community could even comprise lawyers who are part of the plaintiff's steering committees, on discovery committees, and/or just attorneys who can make compelling points.

Various types of data are built on actual metrics, used by defense firms, and more often than not originates from the very insurance companies that developed both these calculation standards as well as the science of damage quantification. For example, metrics can include expert estimations of jurisdictional (how well a law firm may be familiar with, how favorable a judge historically rules in favor of similar cases, and the like), epidemiology (healthcare, injury, and the like), and legality (strength of a legal case) considerations. These metrics are used every day to set key base-line numbers by the people that people whose job it is to pay these damages. These metrics, criteria, factors, and sub factors are all structured in a logical and systemic fashion, setting the standard across all industries, and are increasingly relied on by the courts.

Users 104 have the ability to provide customer satisfaction feedback data to the provider of the mass tort management, investment, or procurement system 100 such that the mass tort management, investment, or procurement system 100 can be improved over type.

Any one of the above types of data or sources of data can be gathered from the community, in real time, and combined with streamflow data, historical data, and run through insurance-based metrics. The metrics, being set and/or reviewed by experts, are then analyzed with artificial intelligence to amalgamate all of the user data for use in equations for making estimates, etc.

The non-transitory computer readable medium 102 and/or other non-transitory computer readable media 108 are each powered by a power supply. Each power supply outputs a particular voltage to a device, component, or set of components of a device. One power supply may power more than one device, component, or set of components of a device. The power supply could be a direct current (“DC”) power supply (e.g., a battery), an alternating current (“AC”) power supply, a linear regulator, etc. The power supply can be configured with a microcontroller to receive power from other grid-independent power sources, such as a generator or solar panel.

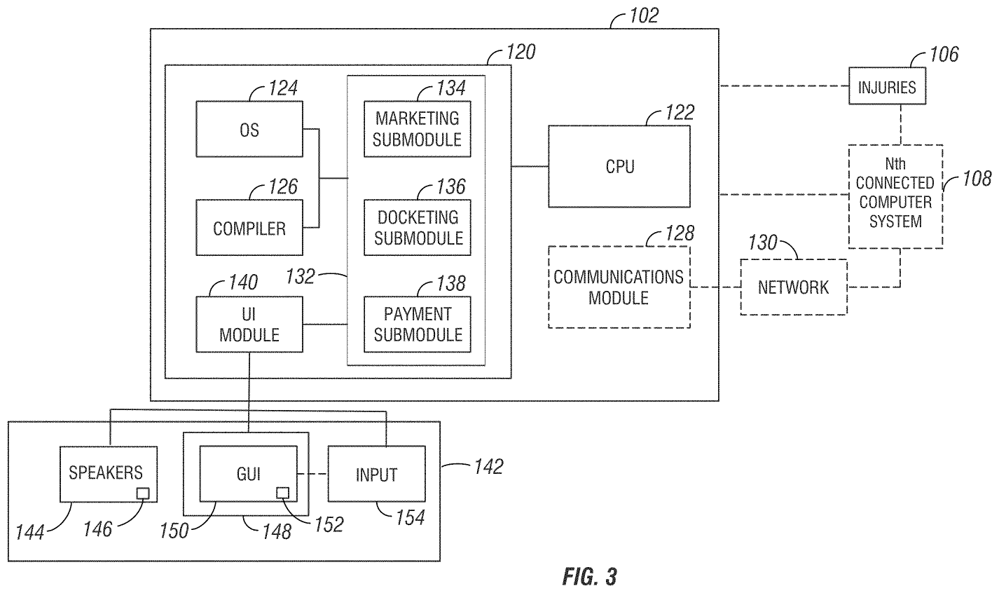

FIG. 3 shows an exemplary non-transitory computer readable medium 102 that could be used to implement selected elements of the present invention, including memory 120 and a user interface (“UI”) 142. The non-transitory computer readable medium 102 may also include components such as an intelligent control and communication components. Examples of such intelligent control units may be a central processing unit 122 alone or in tablets, phones, handheld devices, laptops, user displays, or generally any other computing device capable of allowing input, providing options, and showing output of electronic functions. Still further examples include a microprocessor, a microcontroller, or another suitable programmable device and a memory. The controller also can include other components and can be implemented partially or entirely on a semiconductor (e.g., a field-programmable gate array (“FPGA”)) chip, such as a chip developed through a register transfer level (“RTL”) design process.

The memory 120 includes, in some embodiments, a program storage area and a data storage area. The program storage area and the data storage area can include combinations of different types of memory, such as read-only memory (“ROM”, an example of non-volatile memory, meaning it does not lose data when it is not connected to a power source) or random access memory (“RAM”, an example of volatile memory, meaning it will lose its data when not connected to a power source). Some additional examples of volatile memory include static RAM (“SRAM”), dynamic RAM (“DRAM”), synchronous DRAM (“SDRAM”), etc. Additional examples of non-volatile memory include electrically erasable programmable read only memory (“EEPROM”), flash memory, a hard disk, an SD card, etc. In some embodiments, the central processing unit 122, such as a processor, a microprocessor, a microcontroller, or an arithmetic logic unit (“ALU”) is connected to the memory 120 and executes software instructions that are capable of being stored in a RAM of the memory (e.g., during execution), a ROM of the memory (e.g., on a generally permanent basis), or another non-transitory computer readable medium such as another memory or a disc.

Generally, the non-transitory computer readable medium 102 operates under control of an operating system 124 stored in the memory 120. The non-transitory computer readable medium 102 also implements a compiler 126 which allows a software application written in a programming language such as COBOL, C++, FORTRAN, or any other known programming language to be translated into code readable by the central processing unit 122. After completion, the software application accesses and manipulates data stored in the memory 120 of the non-transitory computer readable medium 102 using the relationships and logic that was generated using the compiler 126.

In one embodiment, instructions implementing the operating system 124, a software application, and the compiler 126 are tangibly embodied in the non-transitory computer readable medium 102, which could include one or more fixed or removable data storage devices, such as a zip drive, floppy disc drive, hard drive, CD-ROM drive, tape drive, etc. Furthermore, the operating system 124 and the software application are comprised of instructions which, when read and executed by the non-transitory computer readable medium 102, causes the non-transitory computer readable medium 102 to perform the steps necessary to implement and/or use the present invention. A software application and/or operating instructions may also be tangibly embodied in memory 120 and/or a communications module 128, thereby making the software application a product or article of manufacture according to the present invention.

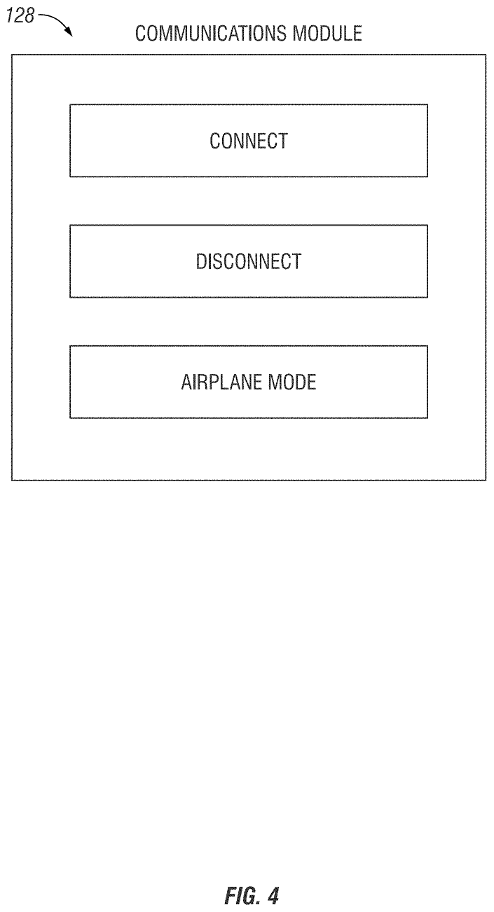

The communications module 128 (as shown in more detail with reference to FIG. 4) can comprise data communication devices to allow the non-transitory computer readable medium 102 to connect to a network 130. The communications module 128 is capable of performing communications module functions and/or steps. Namely, the communications module 128 can provide the ability to connect or disconnect to the network 130. Additionally, the communications module 128 can provide the ability to allow the non-transitory computer readable medium to engage airplane mode, which may or may not disable non-essential components and/or functions, such as a GPS receiver associated therewith. The network 130, for example, may also be connected to the Internet, other media controlling devices 108, and/or the database 110.

In some embodiments, the network 130 is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communications protocols, such as Wi-Fi, Bluetooth, ZigBee, near field communication (“NFC”), etc., although other types of networks are possible and are contemplated herein. The network 130 typically allows communication between the communications module 128 and a central location during moments of low-quality connections. Communications through the network 130 can be protected using one or more encryption techniques, such as those techniques provided in the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

In some embodiments, the non-transitory computer readable medium 102 could include one or more communications ports such as Ethernet, serial advanced technology attachment (“SATA”), universal serial bus (“USB”), or integrated drive electronics (“IDE”), for transferring, receiving, or storing data.

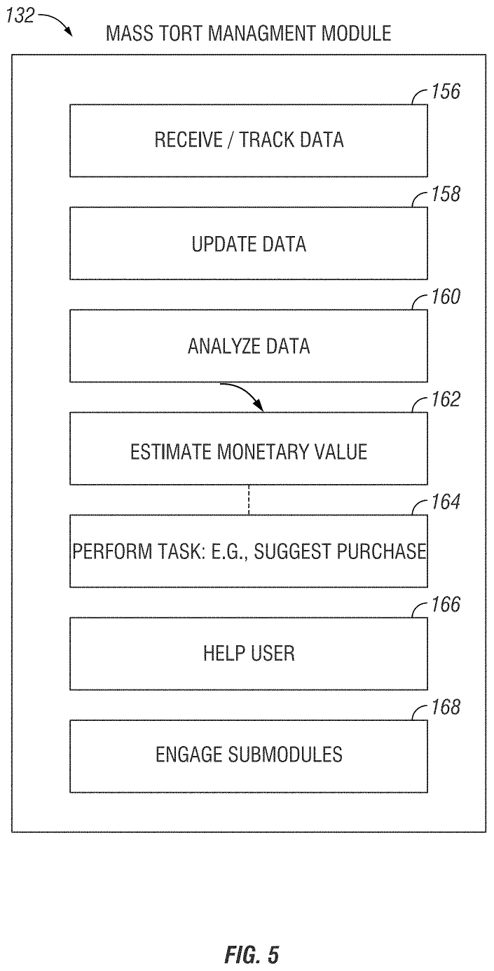

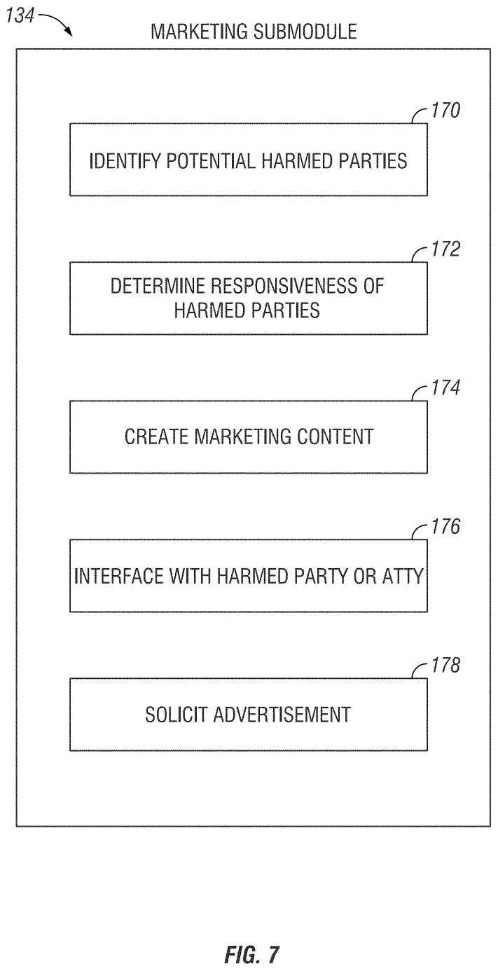

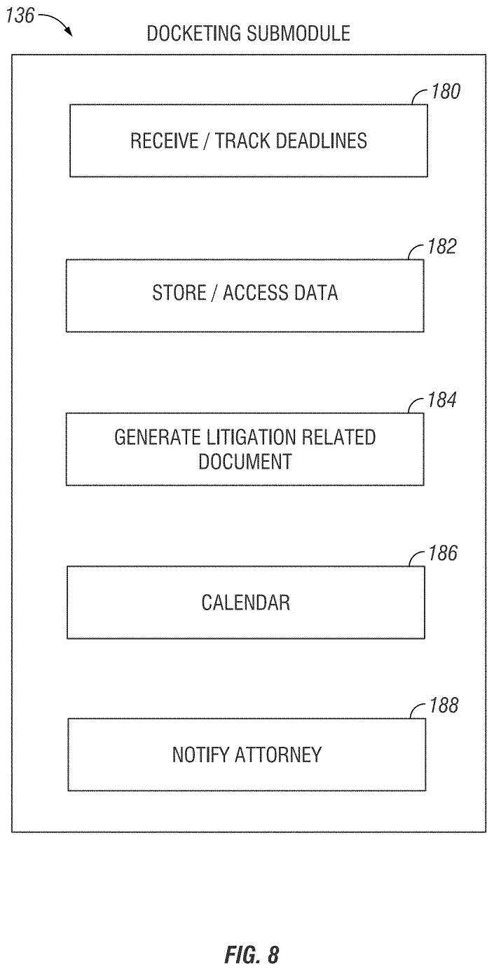

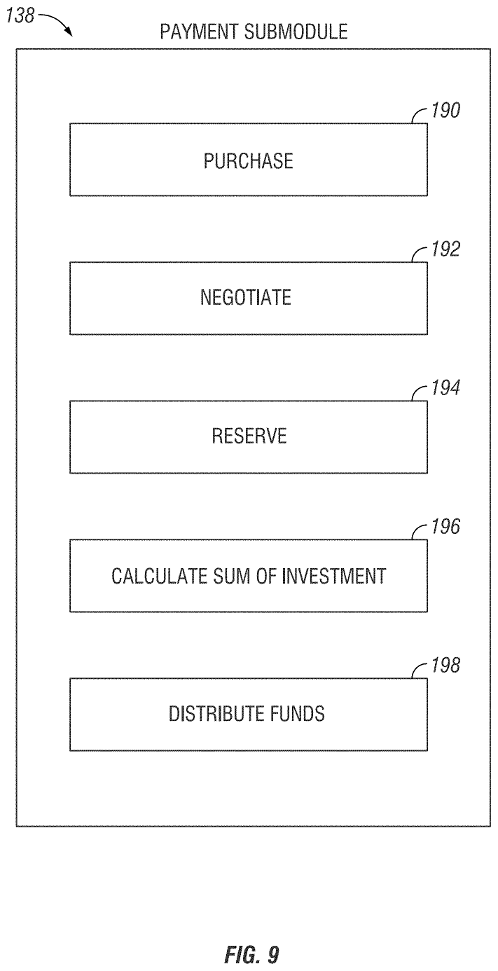

In a preferred embodiment, the program storage area and/or data storage areas comprise a mass tort management, investment, or procurement module 132 (discussed in more detail with reference to FIG. 5), a marketing submodule 134 (discussed in more detail with reference to FIG. 7), a docketing submodule module 136 (discussed in more detail with reference to FIG. 8), a payment submodule 138 (discussed in more detail with reference to FIG. 9), and a user-interface module 140.

Each module works synergistically to analyze the data stored in the database 110. Together, the modules act as a processor of legal data, where different types of data are constantly moving through—a pipe which can accommodate smaller pipes into which contain these different types of data (the raw materials). The modules mix all the data together, weigh all the data proportionally against each other, average the data out, perform calculations (e.g., multiplying a potential return on investment by an expert estimation of a reliability percentage of the same), and then put the data in a location to be viewed by the user 104, customized for the user 104 consistent with the user's preferences. Individual preferences are not just tied in as a receiver of weighted info, but actually influence the weight of calculations as well, as the preferences combine pre-set estimates with artificial intelligence.

The data within the database 110 can include additional metadata and/or identifying information. News and updates can be cross-linked to articles, tagged with insights and tips, and/or tracked for updates, etc. Tags could, for example, read “medical device”, “pharmaceutical”, “personal injury”, “insurance”, “high risk”, or any other desirable phrase(s), or could even comprise images. More than one tag could be included with news and updates.

This steady stream of intel can eventually be fed into the investment solution and is given “weight” (a value integer) which impacts the various calculations performed by the modules. The modules can thus estimate investment risk, value, and ultimate worth can be based by the individual user 104, again consistent with the user's preferences. Thus, news for one user is not necessarily news for another user.

The modules integrate these critical data points that are then run through tort-metrics and thus include additional information. The data is run through a matrix of established tort protocols and formulas and then calculated against/over a thousand points of intangible criterion set by the experts and industry insiders. These data-points can be set and monitored as legal opinions from a panel of expert analysists and/or modified by the attorney-user 104, making the mass tort management, investment, or procurement system 100 the most interactive investment tool in any industry.

Thus, a novel way to estimate settlement factors and actual case value/worth has emerged. The impact, the permeance, and the multiple damage tiers can be measured; even historical data can help determine or calculate settlements in similar torts. Supply and demand are also considered. If serious injuries on a particular tort become more desirable to litigate—leads which relate to moderate injuries may come down in price and the price of leads relating to serious injuries may go up. The tort itself may be colorized by sheer popularity alone.

The non-transitory computer readable medium 102 interfaces with the user 104 to accept input(s) and commands through at least part of the user interface 142 and to present results through the user interface module 140. Although the user interface module 140 is depicted as a separate module, the instructions performing the user interface functions can be resident or distributed in the operating system 124, another software application, or module. Alternatively, the instructions can be implemented with special purpose memory and processors.

The user interface 142 could be a digital interface, a command-line interface, a graphical user interface (“GUI”) 150, or any other way a user can interact with a machine. For example, in a preferred embodiment, the user interface 142 comprises speakers 144, a display 148, and one or more means for receiving an input 154 from the user 104. The speakers 144 can transmit audio, such as an audio notification 146, in response to instructions received from the operating system 124, the mass tort management, investment, or procurement module 132, the marketing submodule 134, the docketing submodule 136, the payment submodule 138, and/or the user interface module 140. Non-limiting examples of the audio notification 144 include a chime, music, a voice message, an alert, or the like.

The display 148 typically comprises an electronic screen which projects a graphical user interface 150 to the user 104. More particularly, the display could be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The graphical user interface 150 may employ visual notifications 152 in response to instructions received from the operating system 124, the mass tort management, investment, or procurement module 132, the marketing submodule 134, the docketing submodule 136, the payment submodule 138, and/or the user interface module 140. Non-limiting examples of the visual notification 152 include an icon, image, a video message, an alert, or the like.

The means for receiving an input 154 can comprise a combination of digital and analog input and/or output devices or any other type of user interface input/output device required to achieve a desired level of control and monitoring for a device. Examples of input and/or output devices include computer mice, keyboards, touchscreens, knobs, dials, switches, buttons, etc. Input(s) 154 received from the user interface 142 can then be sent to a microcontroller to control operational aspects of a device.

In some embodiments, the operating system 124, user interface module 140, user interface 142, and/or means for receiving an input 154 can be included with a virtual assistant (e.g., such as those virtual assistants commonly known to the public as Alexa, Cortana, Siri, Bixby, Google Assistant, etc.) which comprises a natural-language user interface. The virtual assistant is capable of using voice queries to ask and answer questions, thereby allowing allows for a voice of the user 104 to act as an input to the non-transitory computer readable medium 102. The virtual assistant's ability to speak to the user 104 may help facilitate nearly instantaneous interaction with the non-transitory computer readable medium 102 and thereby reduce the time it takes to provide more complicated input(s) 154.

### Operation

As shown in FIG. 5, the mass tort management, investment, or procurement module 132 works to receive and track 156, in real time, data from database(s) 110. For a single mass tort litigation, the mass tort management, investment, or procurement module 132 must be able to identify data which relates to a common cause for injury. For example, some of the data may be tagged with identifying information that lets a user 104 know that the tagged data relates to use of a defective medical device sold under a common trade name. In some embodiments, it will be possible for the user 104 to manually update 158 the data.

The mass tort management, investment, or procurement module 132 then takes all the data and undergoes comprehensive analysis 160. Said comprehensive analysis can, for example, provide the user 104 with at least research tools and displays, allowing users to track 156 and better understand the data with useful charts, graphs, or images. In other words, costs, supply and demand, risks, and other data are now personalized and customizable as attractive displays that can be combined with news and insider information from the media and even law firms at the center of the litigation. The data is captured, translated, and displayed visually and in real-time though tools that allow maximum flexibility (e.g., a build-your-own dashboard style approach).

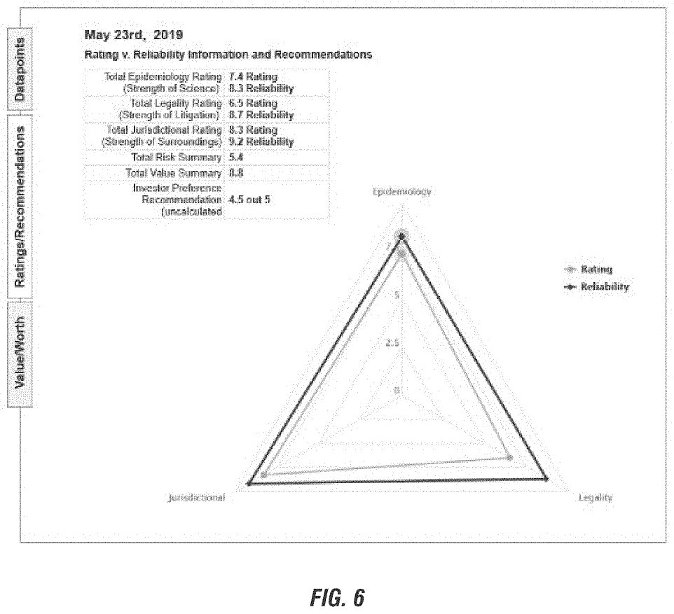

The data, news, and information now displayed can be compiled and run through a matrix of established tort protocols and formulas and then aligned with criterion set by the individual investors and firms providing the solution. Thus, for the first time, there is a mass tort management, investment, or procurement module 132 capable of accurately estimating 162 risk and/or monetary values and providing recommendations or performing 164 tasks (e.g. suggesting purchases) based on the same. These recommendations can often be communicated to the user 104 through useful charts, graphs, and/or images, such as the image shown in FIG. 6. These evaluations are more complex than the “set it and forget it” technology commonly used by used car corporations. The solution now runs across all torts, encompasses, and reflects the changes of thousands of factors, all moving in real-time.

Estimation 162 of the monetary value of specific legal rights can still be based on a single unit, such as “cost-per-case”, “cost-per-lead”, or conversion rate. Breaking this down further, specific gradients or levels of injury inside of a particular tort are often present. These case acquisition costs are continuously in motion and are impacted by a myriad of factors, such as how many causes of action exist, how identifiable harmed parties are and how susceptible the same are to advertising, a probability of success and failure in litigation, how sophisticated or how many competitor law firms seek to enter and exit the active marketing arena, how long an investment is to be tied up during legal proceedings and/or before settlement, and the like. These factors not only affect the cost of pursuing, but also the potential return of a specific mass tort litigation. The mass tort management, investment, or procurement module 132 calculates issues surrounding the life-cycle of the litigation. For example, as more law firms become involved, the ability to get new cases diminishes, raising prices along the way.

In addition to offering 164 automated recommendations as to what is perhaps a ‘good buy’ and what is too expensive or too risky, the mass tort management, investment, or procurement module 132 can receive 156 even expert human recommendations and special deals built in from sellers and potential investor partners, even from the litigating firms themselves. For example, through the mass tort management, investment, or procurement module 132, the potential partners could offer a greater referral percentage if the case acquisition attorney can lock in a certain number of cases by a certain time.

The mass tort management, investment, or procurement module 132 takes into account the scope of experience of its users 104 and their varied levels of knowledge of mass torts. Thus, the mass tort management, investment, or procurement module 132 typically includes a help menu or other means (e.g., eLearning training tools) for educating 166 users 104 on how to use the mass tort management, investment, or procurement module 132.

To better optimize performance of the overall mass tort management, investment, or procurement system 100 and its associated hardware, the mass tort management, investment, or procurement module 132 may engage 168 one or more submodules, including, but not limited to a marketing submodule 134, a docketing submodule 136, and a payment submodule 138, each of which being described in more detail with reference to FIGS. 7-9. More particularly, separate programmatic modules can help increase performance speed of the non-transitory computer readable medium 102 because the performance of just one or a few related tasks will not require compilation (with the compiler 126) and/or execution of all software applications stored within the memory 120 at a single time.

This “microservice architectural style” is an approach to developing a single application as a suite of small services, each running in its own process and communicating with lightweight mechanisms, for example over HTTP resource APIs. These services are built around business capabilities and independently deployable by fully automated deployment processes. Following this approach, the mass tort management, investment, or procurement system 100 has the ability to easily add new features and functionality without impacting running services. As buyers, sellers, products, and services onboard, each module can scale independently to accommodate the transactions and traffic.

For example, a distinct marketing submodule 134 (functions and/or steps of which being illustrated in FIG. 7) can be responsible for helping marketing firms identify 170 potential harmed parties, determine 172 responsiveness of the harmed parties, create 174 marketing content geared towards the harmed parties, electronically interface 176 (for example, by broadcasting a two-way live video feed over a network connection) with the harmed parties or attorneys to discuss the purchase of legal rights of the harmed parties, and even solicit 178 advertisements.

Similarly, a distinct docketing submodule 136 (functions and/or steps of which being illustrated in FIG. 8) can be responsible for receiving and tracking 180 deadlines. For example, after purchases are made, user/account information 114 can be stored and/or accessed 182 by a full “My Account” portfolio/docket management system associated with the docketing submodule 136. The docketing submodule 136 allows users 104 to see the legal status of each case from sign-up to settlement. Furthermore, if the database 110 is integrated with cloud-based case-management systems, authorized users 104 can see relevant case information, such as everything from evidence records to depositions.

The docketing submodule 136 can even be used to generate 184 portion(s) of litigation related document(s) based on data in the database 110, allows user to view a calendar 186 of litigation related events, and even notify 188 attorneys of litigation related events or deadlines (such as through audio notification 146 and/or visual notification 152).

In yet another exemplary embodiment, using a distinct payment submodule 138 136 (functions and/or steps of which being illustrated in FIG. 9) allows users 104, such as attorneys, to purchase 190, negotiate 192 the purchase of, or even reserve 194 the purchase of legal rights of harmed parties. This allows attorneys the ability to easily invest in entire dockets of cases, with data from all the marketing submodule 134 being displayed on the screen. For the first time, attorneys can be sure this new transparent system 100 is giving them the direct costs.

The payment submodule 138 can deliver ticker-tape style prices and information based on the first-ever merging of real-time data/tracking feeds. Because the mass tort/litigation data 112 information is all in one place and in real-time for the first time, the clarity provided by the combination of this data is exponentially enhanced. Real-time feeds, can for example, come from Google and other search engines, Facebook and other social media platforms, and television (TV). The real-time feeds can then be fed directly into the mass tort management, investment, or procurement system 100, amalgamated, and integrated with cloud-based intake software and other streaming, marketing, and intake data.

### Investment

How does an attorney “invest” in a mass tort docket? First, as the term “mass” implies, we can assume they are not interested in acquiring a single case, but rather a group or docket of cases—perhaps a dozen, or just as likely a thousand.

As case acquisition costs may vary tremendously—these inconsistencies are affected by the medium used to reach “candidates” (TV, Facebook, etc.), the quality of each case, the stage (or lifecycle) of the tort, the efficiency of the campaign, and the desired profit margins of the case providers. As a result, there is no definitive, standardized, transparent listing currently available of case-acquisition costs. There is not even a standard method of measurement in place to facilitate transactions. Were you to go to 10 case-generation companies, you′d likely get 10 entirely different deals, prices and approaches.

Naturally, with no standardized data, there are no tools to conduct research, no rating, recommendations, assessment of value and worth without the solution presented herein. Moreover, there is no way to spot trends or get a real-time snapshot of costs or “case-conversion.”

Beside this acute lack of information and transparency—the industry is plagued with a myriad of other variables. True data calculations of even the largest dockets is a science still in its infancy. Both the buyers and sellers often base their transactions on the single-case unit called “cost-per-case” (and breaking this down further, specific gradients or levels of injury inside of a particular tort are often suspected but require medical record to confirm). These case acquisition costs are continuously in motion and are impacted by the myriad of factors which are particularly discussed throughout the present disclosure.

Ironically, even with this chaos and confusion, mass tort investing is by far the fastest growing sector in the legal industry, and, as more law firms dive in, the ability to get new cases continues to diminish, thus raising prices along the way. Currently over a hundred million dollars is invested in mass torts by law firms every year while the number of attorneys entering the mass tort space is growing by over 20% a year.

Make no mistake, investing in mass torts is a risk. In many ways, the ‘up and down’ volatility as a tort moves through the litigation cycle has striking similarities to the stock market. Mass tort lawyers are often forced to act like ‘blind’ day-traders in trying to outthink a plethora of market factors and speculate both on the biggest returns and the least risky. As always, information is key, and the ability to act on it, is everything.

And, in an industry where the playing field is not well-defined, and transparency is actually shunned, attorneys must try and guess the rules, calculate investments from hearsay, in a language that is undefined, in order to do closed door deals and navigate acquisitions that are worth millions of dollars.

For example, if a lawyer invests a large sum of money, e.g., hundreds of thousands of dollars, into cases dealing with a particular pharmaceutical recall, the payment submodule 138 will give the lawyer the ability to calculate 196 and view how much he or she is spending while it is being spent. The lawyer will see how many leads are coming in from said spending, how many leads are being signed as cases, and even how promising the cases are. This data can then be compared to other campaigns (forming a base-line) to see where the lawyer's campaign sits and how much above or below average the lawyer is running. The data can show, from the marketing company presenting the solution, how much a case costs today and even take marketing data from multiple sources, thereby centralizing and giving other attorneys choices of who to buy from. Captured over time, the payment submodule 138 and other aspects of the mass tort litigation module 132 work together to analyze trends. Such analysis is then used to calculate the best time to buy and how much to spend.

Yet unlike the stock market, certain distinctions make the mass tort space entirely unique. Formerly, attorneys would market for their own firm to handle mass tort cases. These attorneys would work on the cases until a point at which they could obtain a settlement. For doing so, the attorneys would obtain usually around 33%-40% of the total settlement.

Currently, some lawyers prefer to just focus on the marketing side to get their cut. These attorneys can profit solely from the “referral” or “joint venture” fees, which can be as much as 50% of the total legal fees. In the mass tort arena, law firms have been keen to notice writing a large check to a marketing company does not guarantee the law firm will not lose the case to another law firm. These other law firms are then able to pocket a significant portion of the legal fees while doing very little of the work. Thus, to help law firms mitigate this risk, sometimes both investing law firms and marketing law firms work together and share referral fees. The ability to make a substantial share of the settlement money, not by handling cases, but instead just getting cases or even simply investing in getting cases, is all part of today's system that makes mass torts so unique—and ripe for progress.

For the legal marketers (some of which are traditional marketing companies, and some are law firms who have developed an expertise for this), getting the cases for investing law firms can be done through traditional legal marketing—creating 174 TV ads, the internet, social media, etc. For them, the issue of fluctuating cases costs is a huge factor in determining the “cost-per-case” price they will propose when bidding to acquire a docket of cases for a firm. Typically, these groups must hedge their bets against the rising and falling “case acquisition costs” and they typically build in a protective “cushion”. Currently, these risk-minimizing “margins” are simply accepted as part of the cost of doing business.

There are several other participants in this game of investment, acquisition, and handling. A firm could buy leads instead of cases and use an intake-focused law firm to “close them” (turning the leads into cases). This is done by paying upfront flat-fees of a few hundred dollars (front-end), or around 10% of the legal fees when a settlement occurs and are collected (called the “back-end”). Recently even Hedge Funds have jumped into the mix, loaning money to attorneys on approved torts for a firm to build up a big docket—all at a lower interest rate to law firms that can demonstrate a proficiency at getting the leads and turning them into cases.

This solution can also easily provide “integrated” access to case acquisition financing directly from hedge funds and firms wishing to partner with these attorneys. So if an attorney wants to buy big, partners literately line up for him or her. The buying attorney is then able to meet online, discuss, deal and move forward all while allowing the attorney the ability to compare rates and services having made contact though the solution.

Two, three, or even more law firms can work together just to acquire the cases for the main firm who is working up the case—all of them aiming to be favorably compensated for their work. Thus, funds there must be some mechanism to distribute 198 which satisfies each contributing party. In a non-limiting example, funds may be distributed 198 as follows: 5% to a hedge fund; 25% to the investing firm; 10% to the marketing firm; 10% to the intake firm; and 50% to the litigating firm. It is up to each partner in the process to negotiate their fair share of the overall distribution, which may or may not end up being proportional to the amount of work performed by the partner.

Distribution 198 of funds can happen automatically, such as through the use of a smart contract, and can even depend on what type of work was done or utilized by the law firm litigating the case.

From the foregoing, it can be seen that the present invention accomplishes at least all of the stated objectives.

### LIST OF REFERENCE CHARACTERS

The following reference characters and descriptors are not exhaustive, nor limiting, and include reasonable equivalents. If possible, elements identified by a reference character may replace or supplement any element identified by another reference character.
100 mass tort management, investment, or procurement system
102 non-transitory computer readable medium
104 user
106 injuries
108 additional non-transitory computer readable media
110 database
112 mass tort/litigation data
114 user/account information
116 financial data
118 marketing data
120 memory
122 central processing unit
124 operating system
126 compiler
128 communications module
130 network
132 mass tort management, investment, or procurement module
134 marketing submodule
136 docketing submodule
138 payment submodule
140 user interface module
142 user interface
144 speakers
146 audio notification
148 display
150 graphical user interface
152 visual notification
154 input
156 receiving/tracking (injury data) function/step
158 updating function/step
160 analyzing function/step
162 estimating function/step
164 performing function/step
166 notifying function/step
168 engaging function/step
170 identifying function/step
172 determining function/step
174 creating function/step
176 interfacing function/step
178 soliciting function/step
180 receiving/tracking (deadlines) function/step
182 storing/accessing function/step
184 generating function/step
186 calendar function/step
188 notifying function/step
190 purchasing function/step
192 negotiating function/step
194 reserving function/step
196 calculating function/step
198 distributing function/step
200 chart(s), graph(s), and/or image(s)

The present disclosure is not to be limited to the particular embodiments described herein. The following claims set forth a number of the embodiments of the present disclosure with greater particularity.

What is claimed is:

1. A computer implemented method for managing, investing in, or procuring legal rights in connection with mass tort litigation comprising:
with a mass tort management, investment, or procurement module, tracking data in real time related to a common cause for injury;
estimating, by analyzing the data with the mass tort management, investment, or procurement module, a monetary value to purchase legal rights from one or more harmed parties; and
allowing, with a non-transitory computer readable medium,
a purchase of,
a negotiation of the purchase of, or
an ability to reserve the purchase of,
legal rights of the one or more harmed parties.

2. The computer implemented method of claim 1 further comprising connecting the non-transitory computer readable medium to a network.

3. The computer implemented method of claim 1 wherein the mass tort management, investment, or procurement module is tangibly embodied within the non-transitory computer readable medium.

4. The computer implemented method of claim 1 wherein the non-transitory computer readable medium forms part of a device selected from the group comprising:
a. a mobile phone;
b. a tablet;
c. a laptop or desktop computer;
d. a display; and
e. a gaming console.

5. The computer implemented method of claim 1 further comprising suggesting a purchase or non-purchase of legal rights in connection with a harmed party based upon the data.

6. The computer implemented method of claim 5 further comprising generating a chart or graph in connection with the suggesting of the purchase or non-purchase of legal rights.

7. The computer implemented method of claim 1 further comprising educating a user on how to use the mass tort management, investment, or procurement module.

8. The computer implemented method of claim 1 further comprising notifying an attorney of:
a. a potential purchase, a successful purchase, or an unsuccessful purchase of legal rights in connection with a harmed party;
b. an upcoming deadline; and
c. a change in status of a litigation.

9. The computer implemented method of claim 1 further comprising allowing for manual input of and/or updates to the data.

10. The computer implemented method of claim 1 further comprising distributing funds based, at least in part, upon an identification of who contributed to inputting some of the data used to make a suggestion or to take an action.

11. The computer implemented method of claim 1 further comprising automatically generating a portion of a complaint based, at least in part, on some of the data.

12. The computer implemented method of claim 1 further comprising:
a. encrypting and storing the data on a database or a cloud-based management, investment, or procurement system; and
b. distributing the data using distributed ledger technology.

13. The computer implemented method of claim 1 wherein the data relates to at least two parameters selected form the group comprising:
a. a number of potential claims relating to the common cause for injury;
b. how identifiable or reachable a harmed party is;
c. a location of the harmed party;
d. how responsive the harmed party is to an advertisement;
e. the monetary value;
f. a chance of success or failure of a potential litigation;
g. an expert recommendation;
h. how many other legal entities are competing to litigate an identical or similar case relating to the common cause for injury;
i. how long an investment is likely to be tied up; and
j. a sum of money invested by a legal entity towards a mass tort.

14. A non-transitory computer readable medium comprising:
an operating system;
a memory;
a compiler;
a user interface; and
a mass tort management, investment, or procurement module capable of:
tracking data in real time related to a common cause for injury; and
estimating, through analysis of the data, a monetary value to purchase legal rights from the one or more harmed parties.

15. The computer implemented method of claim 14 further comprising a display for displaying the data.

16. The non-transitory computer readable medium of claim 14 further comprising a means for meeting virtually over a network connection.

17. The non-transitory computer readable medium of claim 14 further comprising a marketing sub-module of the mass tort management, investment, or procurement module capable of soliciting advertisements to the one or more harmed parties.

18. The non-transitory computer readable medium of claim 14 further comprising a docketing sub-module of the mass tort management, investment, or procurement module for keeping track of litigation related deadlines.

19. The non-transitory computer readable medium of claim 14 further comprising a payment sub-module of the mass tort management, investment, or procurement module for allowing a purchase of, a negotiation of the purchase of, or an ability to reserve the purchase of, legal rights of the one or more harmed parties.

20. A mass tort management, investment, or procurement system for tracking injuries comprising:
a database storing data or cloud-based management, investment, or procurement system for storing data related to a common cause for injury, said data including at least:
a. a type of injury selected from the group comprising;
i. medical device;
ii. prescription drug;
iii. product liability; and
iv. toxic contamination; and
b. a monetary value to purchase legal rights from one or more harmed parties; and
a means for updating the data in real time.
